(19) United States
(12) Patent Application Publication
(10) Pub. No.: US 2010/0211925 A1
(43) Pub. Date: Aug. 19, 2010

(54) EVALUATING A SERVICE ORIENTED ARCHITECTURE SHARED SERVICES PROJECT

(75) Inventors: Kishore Channabasavaiah, Palatine, IL (US); Stephen C. Kendrick, Fairfax, VA (US); Raghu Varadan, San Francisco, CA (US); Nevenko Zunic, Hopewell Junction, NY (US)

Correspondence Address: Keohane & D'Alessandro, 1881 Western Avenue Suite 180, Albany, NY, 12203, US

(73) Assignee: Interational Business Machines Corporation, Armonk, NY (US)

(21) Appl. No.: 12/388,533

(22) Filed: Feb. 19, 2009

(51) Int. Cl. G06F 9/44

(52) U.S. Cl. 717/103

(57) ABSTRACT

An approach that evaluates a service oriented architecture (SOA) shared services project is provided. In one embodiment, there is a service discovery tool, including an analysis component configured to analyze a potential SOA shared services project, and a determination component configured to determine whether the potential SOA shared services project should proceed to an inception process based on an analysis of the potential SOA shared services project.

### CROSS-REFERENCE TO RELATED APPLICATIONS

The present application is related in some aspects to commonly owned and co-pending application entitled “Identification of a Service Oriented Architecture Shared Services Project”, assigned attorney docket no. END920080252US1, which was filed on Oct. 29, 2008, commonly owned and co-pending application entitled “Selecting a Service Oriented Architecture Shared Service”, assigned attorney docket no. END920080289US1, which was filed on (to be provided), and was assigned application Ser. No. (to be provided), commonly owned and co-pending application entitled “Designing a Service Specific Service Oriented Architecture Shared Services Solution”, assigned attorney docket no. END920080290US1, which was filed on (to be provided), and was assigned application Ser. No. (to be provided), commonly owned and co-pending application entitled “Constructing a Service Oriented Architecture Shared Service”, assigned attorney docket no. END920080291US1, which was filed on (to be provided), and was assigned application Ser. No. (to be provided), commonly owned and co-pending application entitled “Transitioning to Management of a Service Oriented Architecture Shared Service”, assigned attorney docket no. END920080292US1, which was filed on (to be provided), and was assigned application Ser. No. (to be provided), commonly owned and co-pending application entitled “Management of a Service Oriented Architecture Shared Service”, assigned attorney docket no. END920080293US1, which was filed on (to be provided), and was assigned application Ser. No. (to be provided), commonly owned and co-pending application entitled “Managing Service Oriented Architecture Shared Service Escalation”, assigned attorney docket no. END920080294US1, which was filed on (to be provided), and was assigned application Ser. No. (to be provided), the entire contents of which are herein incorporated by reference.

### FIELD OF THE INVENTION

This invention relates generally to lifecycle management and more specifically to the evaluation and management of SOA shared services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

Current IT lifecycle processes are well suited to managing self-contained and siloed solutions. However, as businesses transition to service oriented architectures (SOA), traditional IT governance methods are inadequate for managing SOA shared services during their entire lifecycle. SOA is not a self-contained and siloed solution. Rather it's a decomposition of solutions into a set of shared services. It is these SOA shared services that require a new lifecycle management system that takes into consideration multiple new processes that are not available or part of existing IT governance systems.

### SUMMARY OF THE INVENTION

In one embodiment, there is a method for evaluating a service oriented architecture (SOA) shared services project. In this embodiment, the method comprises: analyzing a potential SOA shared services project; and determining whether the potential SOA shared services project should proceed to an inception process based on the analyzing.

In a second embodiment, there is a system for evaluating a service oriented architecture (SOA) shared services project. In this embodiment, the system comprises at least one processing unit, and memory operably associated with the at least one processing unit. There is a service discovery tool, including an analysis component configured to analyze a potential SOA shared services project, and a determination component configured to determine whether the potential SOA shared services project should proceed to an inception process based on an analysis of the potential SOA shared services project.

In a third embodiment, there is a computer-readable medium storing computer instructions, which when executed, enables a computer system to evaluate a service oriented architecture (SOA) shared services project, the computer instructions comprising: analyzing a potential SOA shared services project; and determining whether the potential SOA shared services project should proceed to an inception process based on the analyzing.

In a fourth embodiment, there is a method for deploying a service discovery tool for use in a computer system that provides evaluation of a service oriented architecture (SOA) shared services project. In this embodiment, a computer infrastructure is provided and is operable to: analyze a potential SOA shared services project; and determine whether the potential SOA shared services project should proceed to an inception process based on an analysis of the potential SOA shared services project.

### BRIEF DESCRIPTION OF THE DRAWINGS

FIG. 1 shows a schematic of an exemplary computing environment in which elements of the present invention may operate;

FIG. 2 shows a flow diagram of a SOA services lifecycle management process;

FIG. 3 shows a service discovery tool that operates in the environment shown in FIG. 1; and

FIG. 4 shows a flow diagram of a SOA services lifecycle management process for evaluating a SOA shared services project.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to evaluating a service oriented architecture (SOA) shared services project. In these embodiments, a service discovery tool provides this capability. Specifically, the service discovery tool comprises an analysis component configured to analyze a SOA shared services project, and a determination component configured to determine whether the potential SOA shared services project should proceed to an inception process based on an analysis of the potential SOA shared services project. The service discovery tool evaluates interdependent initiatives and plans for services deployment to complete the discovery phase for an identified potential SOA shared services project.

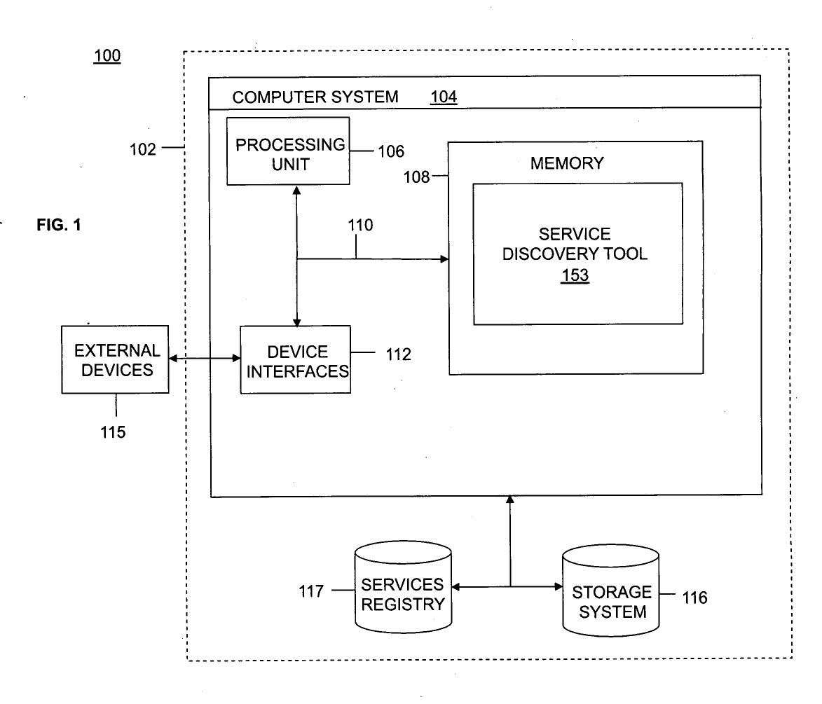

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for evaluating a SOA shared services project. It should be understood that any other computers implemented under the present invention may have different components/software, but will perform similar functions. As shown, computer system 104 includes a processing unit 106, memory 108 for storing a service discovery tool 153, a bus 110, and device interfaces 112.

Processing unit 106, among other things, collects and routes signals representing outputs from external devices 115 (e.g., a keyboard, a pointing device, a display, a graphical user interface, etc.) to service discovery tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating service discovery tool 153, which is stored in memory 108 and/or storage system 116. While executing computer program code, processing unit 106 can read and/or write data to/from memory 108, storage system 116, and a services registry 117. Services registry 117 stores a plurality of services and associated metadata, as well as rules against which the metadata is compared to locate shared services. Storage systems 116 and services registry 117 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

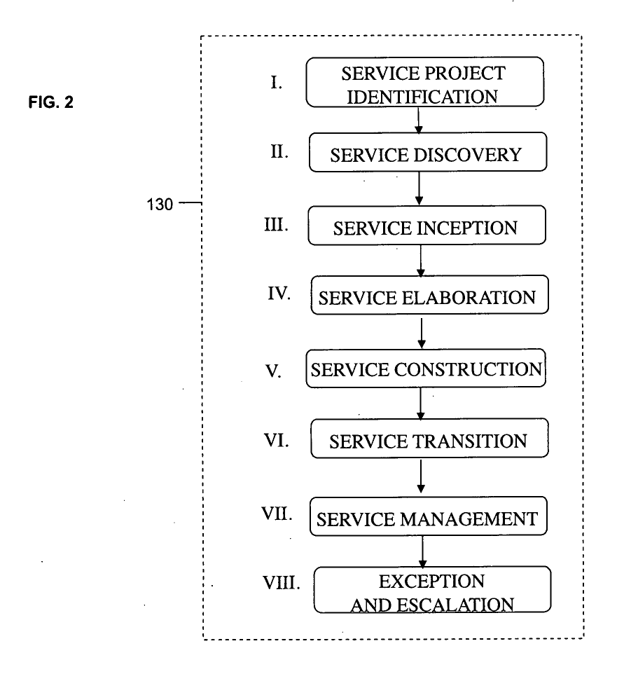

Implementation 100 and service discovery tool 153 operate within a broader SOA services lifecycle management process (SLMP) 130, shown in FIG. 2, which identifies, evaluates, implements, and manages a SOA shared service. SOA SMLP 130 provides guidance for managing the creation of shared services within an enterprise. Specifically, SOA SLMP 130 of the present invention includes distinct roles, governance checkpoints, increased collaboration requirements, and decision control points. SOA SMLP 130 takes an extended view in identifying the various touch-points outside of the organization to plan, build and manage shared services. SOA SMLP 130 starts with the identification of a business initiative(s) (e.g., a business need) having the potential of being a shared service project candidate. The overall process ends with the rollout of shared services fulfilling the identified business initiative, as well as management across its entire life.

SOA SLMP 130 of the present invention consists of the following distinct processes and associated methodologies:
I. New Service Project Identification—the goal of this phase is to evaluate and identify a SOA shared services opportunity (i.e., a business need), and to determine if the SOA shared services opportunity can be met through the use of SOA shared services.
II. Service Discovery—the goal of this phase is to complete the Discovery phase for a project that has been identified as a potential SOA services candidate project.
III. Service Inception—the goal of this phase is to gather the high level requirements for the SOA shared services that will be developed as part of the potential SOA services candidate project.
IV. Service Elaboration—the goal of this phase is to further define the high level requirements from the Inception phase into detailed requirements to complete the service solution design and prepare for the build phase.
V. Service Construction—the goal of this phase is to develop the integration components and integrate the SOA shared services components per the design guidelines while meeting/exceeding the necessary quality requirements so that the services can be deployed for general use.
VI. Service Transition—the goal of this phase is to transition the SOA shared services developed in the Construction phase to the operations team that will be responsible for ongoing SOA shared service maintenance.
VII. Manage Services—the goal of this phase is to manage the SOA shared services once they have been transitioned to the operations team that will be responsible for ongoing SOA shared service maintenance. VIII. Exception and Escalation—the goal of this phase is resolve issues that occur during the SOA services lifecycle process in an expedient manner.

Each of the above processes is a complete methodology that can be implemented independently since they define key stakeholders, affected processes, and touch-points throughout the organization. It will be appreciated that each of the above listed SOA processes are non-limiting examples of the functionality and operation of possible implementations of systems, methods and computer program products according to various embodiments of the present invention. In this regard, each process (I-VIII) may represent a module, segment, or portion of code, which comprises one or more executable instructions for implementing the specified logical function(s) of SOA SLMP 130, as shown in FIG. 2. It should also be noted that, in some alternative implementations, the functions noted in SOA SLMP 130 may occur out of the order listed above in processes I-VIII. For example, two processes shown in FIG. 2 in succession may, in fact, be executed substantially concurrently. It should also be noted that, in another alternative embodiment, additional or fewer process steps may be included in SOA SLMP 130. Further, each process of the flowchart of FIG. 2 can be implemented by special purpose hardware-based systems that perform the specified functions or acts, or combinations of special purpose hardware and computer instructions.

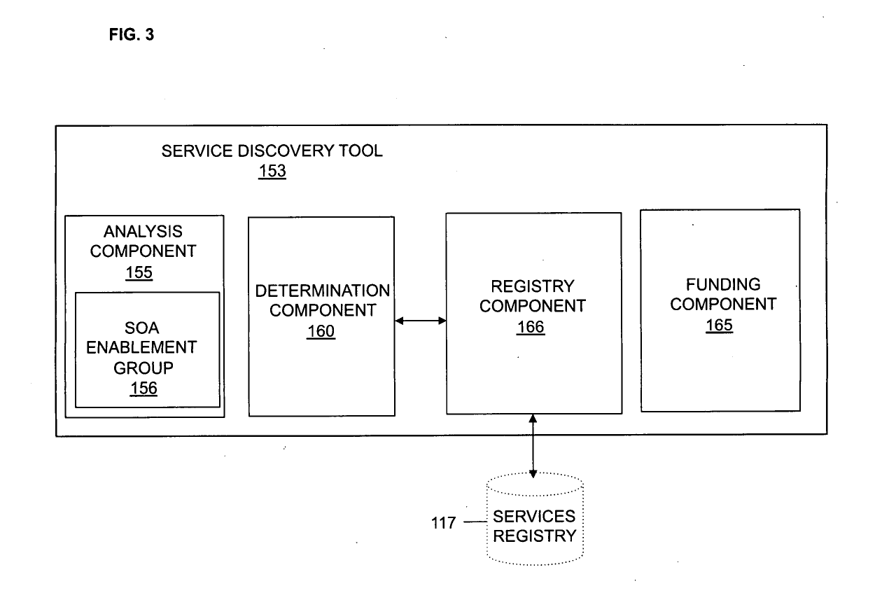

FIG. 3 shows a more detailed view of service discovery tool 153 that evaluates a SOA shared services project, which was established to address a SOA shared services opportunity (i.e., a business need). As shown, service discovery tool 153 comprises an analysis component 155 configured to analyze a potential SOA shared services project. In one embodiment, to accomplish this, input regarding the potential SOA shared services project is provided to a SOA enablement group 156, for example, at a service discovery meeting. This input may comprise virtually any information that assists SOA enablement group 156 to analyze the SOA shared service project. Information is aggregated by SOA enablement group 156 and used as input to the service discovery meeting. Specifically, this information is a “first-pass” at determining which services may potentially exist to meet the documented business need. Additionally, if other entities (i.e., enterprise stakeholders) are involved with the service discovery meeting, the input is useful as an entry point for SOA enablement group 156 to engage the other entities. It will be appreciated that SOA enablement group 156 described herein may represent a committee or group of individuals within an organization, or may represent a module, segment, or portion of code, which comprises one or more executable instructions for evaluating the potential SOA shared services project.

Next, the scope of the potential SOA shared services project is evaluated in terms of funding, costs, and resources necessary for proceeding with the project. In one embodiment, service discovery tool 153 comprises a funding component 165 configured to analyze a funding allocation for each entity (e.g., consumers, providers, groups within an organization, etc.) associated with the potential SOA shared services project. Specifically, each entity is identified, and a determination is made as to how the service will be funded. The funding allocation information is then provided to SOA enablement group 156 as part of its analysis of the potential SOA shared services project. The funding allocation information may be analyzed by SOA enablement group 156, or by another entity based on a desired level of independence or oversight. For example, in one embodiment, the funding allocation may need to be approved by a committee outside of SOA enablement group 156 if it exceeds a predetermined threshold dollar amount. In this example, an automated alert can be generated by funding component 165 if the analysis of the SOA shared services project indicates that a particular funding allocation needs further consideration.

Once the potential SOA shared services project is analyzed, it is determined whether it may proceed to the service inception phase of SOA SLMP 130 (FIG. 2). As shown in FIG. 3, service discovery tool 153 comprises a determination component 160 configured to determine whether the potential SOA shared services project should proceed to the inception process based on the analysis of the potential SOA shared services project. Specifically, determination component 160 reviews the analysis performed by analysis component 155 and SOA enablement group 156, along with the funding allocation analysis performed by funding component 165, and either grants or denies approval. If approval is granted, a registry component 166 enters meta-data of the potential SOA shared services project into services registry 117 based on the determination of whether the potential SOA shared services project should proceed to the inception process, and assigns a status indicator (e.g., “FUNDED” or “APPROVED) to the potential SOA shared services project. SOA SLMP 130 then proceeds to service inception.

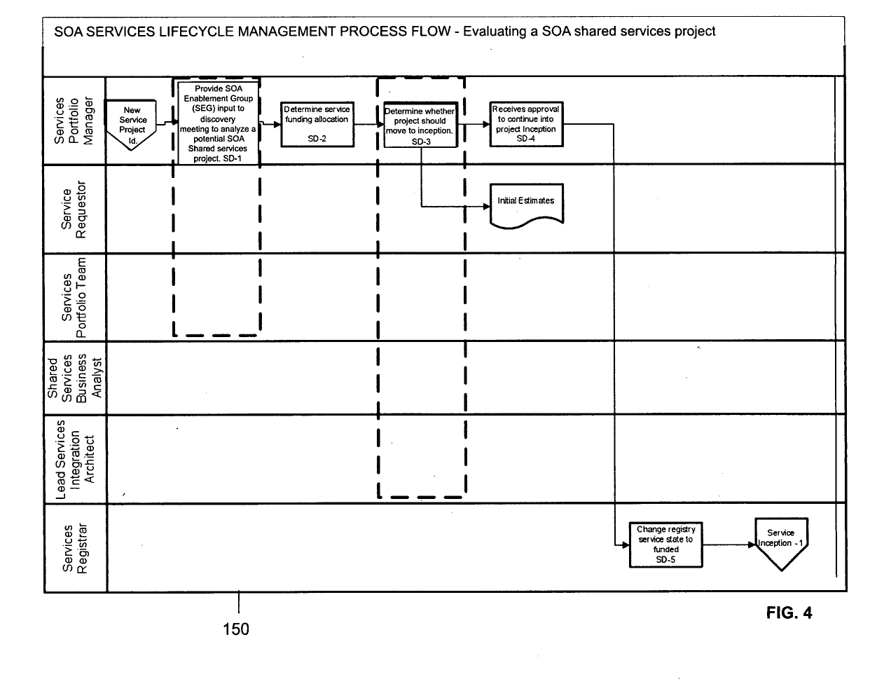

Referring now to FIG. 4, a SOA services lifecycle management process (SLMP) flow 150 for evaluating a SOA shared services project will be described in further detail. As shown, the SOA SLMP flow 150 first analyzes a potential SOA shared services project by providing SOA enablement group input to a discovery meeting at service discovery (SD)-1. Then at SD-2, analysis continues with the determination of a funding allocation for each entity associated with the potential SOA shared services project. At SD-3, a determination is made whether the potential SOA shared services project should proceed to the service inception phase. If approval is received, SOA SLMP flow 150 proceeds to SD-4. At SD-5, the approved SOA shared services project is assigned a “funded” status, meta-data is stored within the services registry, and the process proceeds to service inception.

As shown, FIG. 4 details the organizational roles and responsibilities for each entity in SOA SLMP flow 150. Specifically, SOA SLMP flow 150 identifies shared service roles indicating the primary and secondary (if applicable) roles for each entity (i.e., services registrar, lead services integration architect, shared services business analyst, services portfolio team, service requester, and services portfolio manager) at each process of the potential SOA shared services project. For example, at SD-1, the services portfolio manager is considered to have primary responsibility for analyzing the potential SOA shared services project. Both the service requestor and the services portfolio team are considered to have secondary responsibility. This may mean that the services portfolio manager is given authority and accountability to ultimately make the analysis at SD-1. In this regard, SOA SLMP flow 150 governs the rules of engagement between the various entities. SOA SLMP flow 150 provides integration points between the various entities across different organizational domains involved in the development, integration, deployment and management of SOA shared services, as discussed herein.

It will be appreciated that SOA SLMP flow 150 of FIG. 4 represents one possible implementation of a process flow for evaluating a SOA shared services project, and that other process flows are possible within the scope of the invention. SOA SLMP flow 150 illustrates the architecture, functionality, and operation of possible implementations of systems, methods and computer program products according to various embodiments of the present invention. In this regard, each portion of the flowchart may represent a module, segment, or portion of code, which comprises one or more executable instructions for implementing the specified logical function(s). It will also be noted that each block of flowchart illustration can be implemented by special purpose hardware-based systems that perform the specified functions or acts, or combinations of special purpose hardware and computer instructions.

The present invention provides an approach for evaluating SOA shared services projects. In particular, the present invention includes a service discovery tool comprising: an analysis component configured to analyze a SOA shared services project, and a determination component configured to determine whether the potential SOA shared services project should proceed to an inception process based on the analysis of the potential SOA shared services project. As such, the present invention provides a strategic level of alignment during the evaluation of a SOA shared services project between, for example, IT domains and business domains of an organization.

Further, it can be appreciated that the methodologies disclosed herein can be used within a computer system to provide evaluation of a SOA shared services project, as shown in FIG. 1. In this case, service discovery tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for evaluating a SOA shared services project. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for evaluating a service oriented architecture (SOA) shared services project comprising:
analyzing a potential SOA shared services project; and
determining whether the potential SOA shared services project should proceed to an inception process based on the analyzing.

2. The method according to claim 1, the analyzing comprising analyzing a funding allocation for each entity associated with the potential SOA shared services project.

3. The method according to claim 1 further comprising entering meta-data of the potential SOA shared services project into a services registry based on the determining.

4. The method according to claim 3 further comprising assigning a status indicator to the potential SOA shared services project.

5. A system for evaluating a service oriented architecture (SOA) shared services project comprising:
at least one processing unit;
memory operably associated with the at least one processing unit; and
a service discovery tool storable in memory and executable by the at least one processing unit, the service discovery tool comprising:
an analysis component configured to analyze a potential SOA shared services project; and
a determination component configured to determine whether the potential SOA shared services project should proceed to an inception process based on an analysis of the potential SOA shared services project.

6. The service discovery tool according to claim 5 further comprising a funding component configured to analyze a funding allocation for each entity associated with the potential SOA shared services project.

7. The service discovery tool according to claim 5 further comprising a registry component configured to enter meta-data of the potential SOA shared services project into a services registry based on the determination of whether the potential SOA shared services project should proceed to an inception process.

8. The service discovery tool according to claim 7, the registry component further configured to assign a status indicator to the potential SOA shared services project.

9. A computer-readable medium storing computer instructions, which when executed, enables a computer system to evaluate a service oriented architecture (SOA) shared services project, the computer instructions comprising:
analyzing a potential SOA shared services project; and
determining whether the potential SOA shared services project should proceed to an inception process based on the analyzing.

10. The computer-readable medium according to claim 9 further comprising computer instructions for analyzing a funding allocation for each entity associated with the potential SOA shared services project.

11. The computer-readable medium according to claim 9 further comprising computer instructions for entering meta-data of the potential SOA shared services project into a services registry based on the determining.

12. The computer-readable medium according to claim 11 further comprising computer instructions for assigning a status indicator to the potential SOA shared services project.

13. A method for deploying a service discovery tool for use in a computer system that provides evaluation of a service oriented architecture (SOA) shared services project, comprising:
providing a computer infrastructure operable to:
analyze a potential SOA shared services project; and
determine whether the potential SOA shared services project should proceed to an inception process based on an analysis of the potential SOA shared services project.

14. The method according to claim 13, the computer infrastructure further operable to analyze a funding allocation for each entity associated with the potential SOA shared services project.

15. The method according to claim 13, the computer infrastructure further operable to enter meta-data of the potential SOA shared services project into a services registry based on the determination of whether the potential SOA shared services project should proceed to an inception process.

16. The method according to claim 15, the computer infrastructure further operable to assign a status indicator to the potential SOA shared services project.
